(19) United States
(12) Patent Application Publication
(10) Pub. No.: US 2004/0098743 A1
(43) Pub. Date: May 20, 2004

(54) Prediction of ratings for shows not yet shown

(75) Inventors: Srinivas Gutta, Yorktown Heights, NY (US); Vasanth Philomin, Hopewell Junction, NY (US); Miroslav Trajkovic, Ossining, NY (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/295,670

(22) Filed: Nov. 15, 2002

(51) Int. Cl. G06F 3/00; H04N 5/445; G06F 13/00

(52) U.S. Cl. 725/46

(57) ABSTRACT

A method for generating a recommendation for a video content not yet broadcast. The method including: remotely accessing a user profile of a viewer; and comparing characteristics of the video content to the user profile to generate a recommendation for the video content. Preferably, the accessing and comparing are repeated for a plurality of viewers, wherein for each of the plurality of viewers a corresponding recommendation is generated for the video content resulting in a plurality of recommendations. More preferably, a statistical analysis is performed on the plurality of recommendations to predict a rating for the video content.

### BACKGROUND OF THE INVENTION

1. Field of the Invention

The present invention relates generally to prediction of ratings of shows and other broadcasts not yet shown, and more particularly, to personal video recorders (PVR's) having television recommenders for generating recommendation scores for the shows not yet shown based on a user profile stored in the PVR.

2. Prior Art

Currently, companies such as Nielsen publish ratings after a show has been shown on TV. The ratings are based on actual viewing of the shows, which is monitored by set-top boxes or other electronic equipment. Content owners use the rating to set advertising rates for the shows, the higher the rating, the higher the advertising rate. Ratings for shows not yet shown are currently ascertained by calling up a sampling of potential viewers in select areas and performing a statistical analysis to ascertain a predicted rating for the show. This process is labor intensive and expensive and depends on the truthfulness of the potential viewers. Furthermore, the potential viewers may not realize they prefer shows of the type and having the characteristics of the new show and may unknowingly answer the questions incorrectly.

### SUMMARY OF THE INVENTION

Therefore it is an object of the present invention to provide methods and devices for predicting a rating of video content prior to its broadcast.

Accordingly, a method for generating a recommendation for a video content not yet broadcast is provided. The method comprising: remotely accessing a user profile of a viewer; and comparing characteristics of the video content to the user profile to generate a recommendation for the video content.

Preferably, the method further comprises repeating the accessing and comparing for a plurality of viewers, wherein for each of the plurality of viewers a corresponding recommendation is generated for the video content resulting in a plurality of recommendations. The method more preferably further comprises performing a statistical analysis on the plurality of recommendations to predict a rating for the video content. Preferably, each of the plurality of recommendations is a recommendation score and wherein the performing comprises comparing each of the plurality of recommendation scores to a threshold score above which indicates a likely positive reaction to the video content.

Preferably, the method further comprises allowing the viewer to enable/disable access to the user profile. In which case, the method further comprises compensating the viewer for enabling access to the user profile. Preferably, the compensating comprises allowing the viewer to preview the video content prior to its broadcast to the public. Alternatively, the compensating comprises providing the viewer a discount to view the video content when it is broadcast to the public.

Also provided is a system for generating a recommendation for a video content not yet broadcast. The system comprising: a personal video recorder having a user profile stored therein, the user profile indicating viewing preferences of a viewer based on viewing habits of the viewer; a remote station for remotely accessing the user profile of the viewer; a recommender disposed in one of the personal video recorder or remote station for comparing characteristics of the video content to the user profile and generating a recommendation for the video content; and a communication means for transmitting at least one of the user profile and recommendation between the personal video recorder and the remote station.

Preferably, the recommender is disposed in the personal video recorder and the communication means transmits the recommendation from the personal video recorder to the remote station. Alternatively, the recommender is disposed in the remote station and the communication means transmits the user profile from the personal video recorder to the remote station.

The communication means preferably comprises a modem disposed in at least one of the personal video recorder and remote station.

Preferably, the generation of a recommendation is repeated for a plurality of viewers, wherein for each of the plurality of viewers a corresponding recommendation is generated for the video content resulting in a plurality of recommendations, and wherein remote station further comprises a processor for generating the plurality of recommendations and performing a statistical analysis on the plurality of recommendations to predict a rating for the video content.

The system preferably further comprises means for allowing the viewer to enable/disable access to the user profile.

Still yet provided is a personal video recorder for generating a recommendation for a video content not yet broadcast. The personal video recorder comprising: a memory having a user profile stored therein, the user profile indicating viewing preferences of a viewer based on viewing habits of the viewer; and communication means for receiving a request from a remote station for the user profile and for transmitting one of the user profile or a recommendation based on the user profile to the remote station.

Preferably, the communication means comprises a modem.

The personal video recorder preferably further comprises means for allowing the viewer to enable/disable access to the user profile by the remote station.

Also provided are a computer program product for carrying out the methods of the present invention and a program storage device for the storage of the computer program product therein.

### BRIEF DESCRIPTION OF THE DRAWINGS

These and other features, aspects, and advantages of the apparatus and methods of the present invention will, become better understood with regard to the following description, appended claims, and accompanying drawings where:

FIG. 1 illustrates a schematic view of a preferred implementation of a system of the present invention.

FIG. 2 illustrates a flowchart of a preferred implementation of a method of the present invention.

### DETAILED DESCRIPTION OF THE PREFERRED EMBODIMENT

Although this invention is applicable to numerous and various types of broadcasts, it has been found particularly useful in the environment of television shows. Therefore, without limiting the applicability of the invention to television shows, the invention will be described in such environment.

For purposes of this disclosure, “Broadcast” shall mean when video content is made available to the public, such as by television and cable broadcasts, and also pay-per-view, and video on demand broadcasts. Furthermore, for purposes of this disclosure, “rating” or “ratings” shall mean an indicator of how a video content is received by the public, such as a percentage or number of households actually-viewing the video content upon broadcast (e.g., Nielson rating).

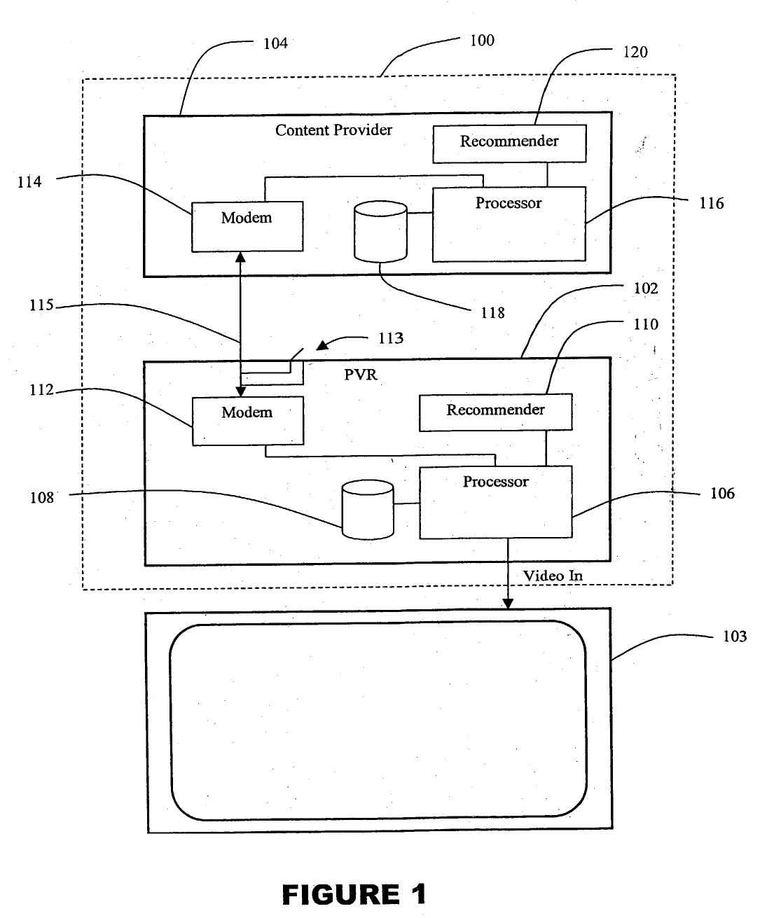

Referring now to FIG. 1, a system for generating a recommendation for a video content not yet broadcast is illustrated, the system being generally referred to by reference numeral 100 and shown within a dotted line. The system includes a personal video recorder 102 (PVR) and a content provider 104. The content provider 104 is anyone or thing that accesses the PVR 102 to carry out the methods of the present invention, such as the video content owner, creator, distributor, or marketing company. The PVR can be integral with a viewing device, such as a monitor 103 or configured as a “set-top” box that feeds a video content to the monitor for viewing, such as those manufactured by TiVo and Panasonic (“Replay TV”).

The PVR 102 generally includes a processor 106 having a storage device 108 for storage of video content, such as movies, broadcast television shows, and the like. The storage device may also store instructions carried out by the processor for controlling the functions of the PVR 102 and may also contain a user profile of a viewer, where the user profile indicates the viewer's viewing preferences, based on his/her viewing history. Alternatively, the instructions and/or user profile may be stored on a different storage device than the video content. The PVR 102 further includes a recommender for generating a recommendation of video content based on the user profile, such recommenders are well known in the art. The recommendation from the recommender can be a simple “thumbs-up/thumbs-down” recommendation or a recommendation score which indicates a likelihood that the viewer will enjoy a certain video content from the viewers viewing history.

As well as receiving video content data, the PVR 102 further has a communication means, such as a modem 112 for communicating with the content provider (alternatively referred to herein as a “remote station” because the content provider is remote from the PVR). The communication means can be any type of wired or wireless communication such as a telephone modem, a satellite transmission, a cellular transmission, or a cable modem. Furthermore, the communication means and video content input may share the same line. The PVR 102 preferably has a means for allowing the viewer to enable/disable access to the user profile, such as a switch 113 which can disconnect the modem 112 from the communication line 115. Such means can also be electronically enabled and controlled with the operation of a pushbutton on the PVR 102 or a remote control (not shown) for use with the PVR 102.

The content provider 104 also has a communication means, such as a modem 114, or any of the alternatives described above, for communicating with the PVR 102. Specifically, the content provider 104 accesses the user profile stored in the PVR 102 and either communicates the same or a recommendation (as will be discussed below) back to the content provider 104 via the modems 112, 114. The content provider 104 also has a processor 116, a storage device 118 operatively connected thereto, and a recommender 120. Although both the PVR 102 and content provider 104 can have a recommender 110, 120, as will be evident from the description below, only one is necessary to carry out the methods of the present invention.

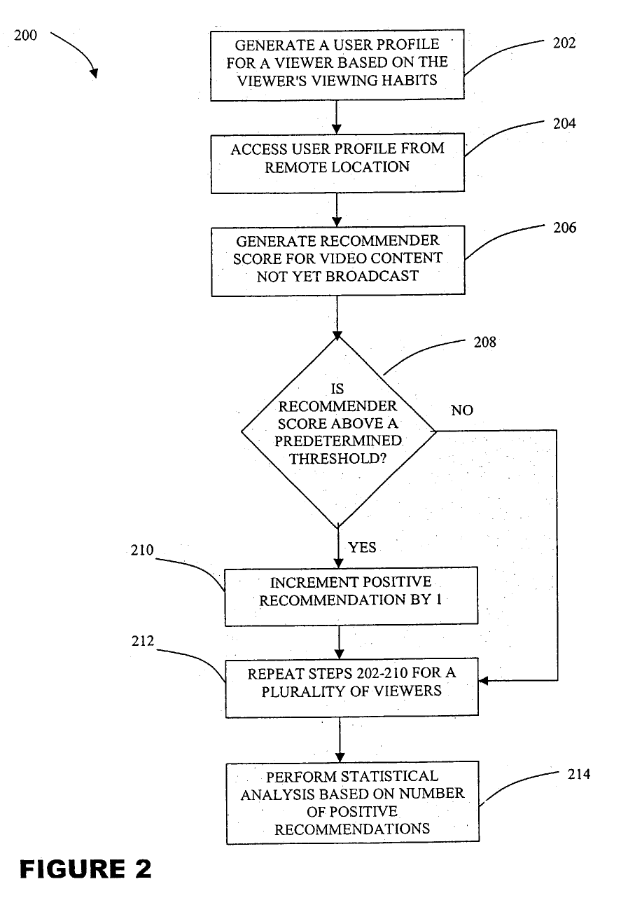

Referring now to FIGS. 1 and 2, a method for generating a recommendation for a video content not yet broadcast will be described, the method being generally referred to by reference numeral 200. At step 202 a user profile is generated and stored in the PVR 102. As discussed above, the user profile indicates viewing preferences of a viewer based on the viewing history of the viewer. A sample user profile is shown in Table 1 below.

TABLE 1

Time > 8:00 AM & time <= 6:00 PM & genre = [news V
business] & station_call_sign = CNBC −→ recommend [0.97]
Station_call_sign = TOON & genre = animation −→ recommend
[0.95]
Station_call_sign = USA & time >= 7:00 PM & time < 10:00 PM
& rating = R & show_description = [violence V sex] & genre =
science fiction & director = Spielberg −→ recommend
[0.87]
Station_call_sign = TNT & genre = [western V action V
violence] & actor = Clint Eastwood −→ recommend [0.74]
Station_call_sign = TLC & genre = biography & title =
America's Great −→ recommend [0.67]
. . .
Do not recommend [1.0]

In the user profile of Table 1, each rule is a set of conjunctive expressions, &-→ and V-→ or. At step 204, the content provider 104 remotely accesses the PVR 102 via the communication means, such as the modems 112, 114, transmits a description of the new show to the PVR 102, and instructs the PVR to read the user profile from the storage device 108. The PVR is further instructed at step 206, to generate a recommendation using the recommender 110, such as a recommendation score, for a video content which has yet to be broadcast, based on the user profile and the new show description. The content provider 104 can have a list of new shows that need to be ascertained if the user would watch, therefore, the content provider 104 matches the individual characteristics of the new show found in the show description against the rules in the user profile. For example if a new show has the following description:

8:00 PM, Friday, USA, Violence, science fiction, R, John Williams, Claudia Schafer, Steven Spielberg, . . . (time, day, channel, show description, genre, rating, actor, actress, director, . . . ),

one can see that this show clearly matches against the 3^{rd} rule in the user profile of Table 1 and the recommendation score for this show would be 0.87 on a scale from 0 to 1.

In the user profile of Table 1, 5 sample rules are given by way of example only. A user profile may contain anywhere from 5 to over 90 rules. The last line in the user profile indicates that if none of the above rules are matched then that show should not be recommended with a probability of 1 or it should be recommended with a probability of 0.

The recommendation score is then transmitted back to the content provider 104 via the modems 112, 114. As described above, the recommendation score is preferably generated at the PVR 102, by recommender 110. In this configuration, the content provider 104 accesses the PVR 102, sends the new show description to the PVR 102, the new show description is matched against the user profile in the PVR 102 and the recommendation score is transmitted back to the content provider 102. Alternatively, the recommendation can be done at the content provider 104, by recommender 120. In this configuration, the recommender 120 resides at the content provider and the PVR 102 has the user profile, and may or may not also have a recommender 110. A disadvantage of the alternative approach is that the content provider 104 has to store each and every viewer's user profile and thus has to maintain a server farm. However an obvious advantage is that the recommendation scores for all the users could be matched against the same recommender engine.

At step 208, it is determined if the recommendation is positive, such as whether the recommendation score is above a predetermined threshold, above which indicates a likelihood that the viewer would enjoy viewing the new show (would have a positive reaction to the video content) based on his/her viewing history. If it is determined that the recommendation is positive, the method proceeds along path 208-YES to step 210, where the number of positive recommendations is incremented by one. The method then proceeds to step 212 where steps 202-210 are repeated for a plurality of viewers, wherein for each of the plurality of viewers a corresponding recommendation is generated for the video content resulting in a plurality of recommendations for each new show. If it is determined for any of the plurality of viewers that the recommendation is negative, the method proceeds to step 212. It is preferred that only the positive recommendations are counted, along with the total number of the plurality of viewers (the difference being assumed to be negative recommendations). However, the negative recommendations can also be counted.

The results of the method are preferably stored at the content provider, such as in storage device 118. Only the number of positive and/or negative recommendations can be stored and/or the recommendation scores themselves may be scored. After a sampling of viewers is completed, a statistical analysis is performed at step 214 on the plurality of recommendations to predict a rating for the video content. Such statistical analysis is well known in the art. Once such ratings are available, the content provider and/or distributors can predict the likelihood that the new show will be well received by the public and may also decide on how much money to charge for advertisements, if the new show is a network broadcast.

Although the methods of the present invention may be carried out without the viewers knowledge, without any degradation of performance of the PVR, and may result in the broadcast of video content that the viewer prefers, the viewer may object to the invasion of his privacy and may not wish to share his/her user profile with the content provider. Therefore, as discussed previously, the viewer can selectively enable/disable access to the user profile by operation of the switch 113 or other like means. As an added incentive for allowing the content provider access to the viewer's user profile, the viewer can be compensated for enabling access to the user profile. Such compensation does not have to be monetary, but may be allowing the viewer to preview the video content prior to its broadcast to the public or providing the viewer a discount to view the video content when it is broadcast to the public.

The methods of the present invention are particularly suited to be carried out by a computer software program, such computer software program preferably containing modules corresponding to the individual steps of the methods. Such software can of course be embodied in a computer-readable medium, such as an integrated chip or a peripheral device.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

What is claimed is:

1. A method for generating a recommendation for a video content not yet broadcast, the method comprising:
remotely accessing a user profile of a viewer; and
comparing characteristics of the video content to the user profile to generate a recommendation for the video content.

2. The method of claim 1, further comprising repeating the accessing and comparing for a plurality of viewers, wherein for each of the plurality of viewers a corresponding recommendation is generated for the video content resulting in a plurality of recommendations.

3. The method of claim 2, further comprising performing a statistical analysis on the plurality of recommendations to predict a rating for the video content.

4. The method of claim 3, wherein each of the plurality of recommendations is a recommendation score and wherein the performing comprises comparing each of the plurality of recommendation scores to a threshold score above which indicates a likely positive reaction to the video content.

5. The method of claim 1, further comprising allowing the viewer to enable/disable access to the user profile.

6. The method of claim 5, further comprising compensating the viewer for enabling access to the user profile.

7. The method of claim 6, wherein the compensating comprises allowing the viewer to preview the video content prior to its broadcast to the public.

8. The method of claim 6, wherein the compensating comprises providing the viewer a discount to view the video content when it is broadcast to the public.

9. A system for generating a recommendation for a video content not yet broadcast, the system comprising:
a personal video recorder having a user profile stored therein, the user profile indicating viewing preferences of a viewer based on viewing habits of the viewer;
a remote station for remotely accessing the user profile of the viewer;
a recommender disposed in one of the personal video recorder or remote station for comparing characteristics of the video content to the user profile and generating a recommendation for the video content; and
a communication means for transmitting at least one of the user profile and recommendation between the personal video recorder and the remote station.

10. The system of claim 9, wherein the recommender is disposed in the personal video recorder and the communication means transmits the recommendation from the personal video recorder to the remote station.

11. The system of claim 9, wherein the recommender is disposed in the remote station and the communication means transmits the user profile from the personal video recorder to the remote station.

12. The system of claim 9, wherein the communication means comprises a modem disposed in at least one of the:personal video recorder and remote station.

13. The system of claim 9, wherein the generation of a recommendation is repeated for a plurality of viewers, wherein for each of the plurality of viewers a corresponding recommendation is generated for the video content resulting in a plurality of recommendations, and wherein the remote station further comprises a processor for generating the plurality of recommendations and performing a statistical analysis on the plurality of recommendations to predict a rating for the video content.

14. The system of claim 9, further comprising means for allowing the viewer to enable/disable access to the user profile.

15. A personal video recorder for generating a recommendation for a video content not yet broadcast, the personal video recorder comprising:
a memory having a user profile stored therein, the user profile indicating viewing preferences of a viewer based on viewing habits of the viewer; and
communication means for receiving a request from a remote station for the user profile and for transmitting one of the user profile or a recommendation based on the user profile to the remote station.

16. The personal video recorder of claim 15, wherein the communication means comprises a modem.

17. The personal video recorder of claim 15, further comprising means for allowing the viewer to enable/disable access to the user profile by the remote station.

18. A program storage device readable by machine, tangibly embodying a program of instructions executable by the machine to perform method steps for generating a recommendation for a video content not yet broadcast, the method comprising:
remotely accessing a user profile of a viewer; and
comparing characteristics of the video content to the user profile to generate a recommendation for the video content.

19. A computer program product embodied in a computer-readable medium for generating a recommendation for a video content not yet broadcast, the computer program product comprising:
computer readable program code means for remotely accessing a user profile of a viewer; and
computer readable program code means for comparing characteristics of the video content to the user profile to generate a recommendation for the video content.
